(19) United States
(12) Patent Application Publication
(10) Pub. No.: US 2004/0172262 A1
(43) Pub. Date: Sep. 2, 2004

(54) Security transportation device

(76) Inventors: Donna L. Gonzales, Pocatello, ID (US); Peter Gonzales, Pocatello, ID (US)

Correspondence Address: STEPHEN M. NIPPER, DYKAS, SHAVER & NIPPER, LLP, P.O. BOX 877, BOISE, ID, 83701-0877, US

(21) Appl. No.: 10/376,222

(22) Filed: Feb. 28, 2003

(51) Int. Cl. G06F 17/60

(52) U.S. Cl. 705/1

(57) ABSTRACT

A system for providing for the transportation of a prohibited item owned by a passenger upon the vehicle upon which said passenger is traveling. The system providing a security bag for the secure transportation of said prohibited item. Into this security bag is placed the prohibited item. The prohibited item being sealed within the security bag. The security bag being coded with identification information identifying which passenger the prohibited item belongs to. The passenger being provided with a receipt. The security bag being placed upon the vehicle and transported with the passenger, but not in the control of the passenger. At the destination, upon confirmation of ownership, the security bag and/or its contents are returned to the passenger.

### BACKGROUND OF THE INVENTION

1. Field of the Invention

The present invention generally relates to bailment, and more particularly relates to the transportation of prohibited items upon an airplane.

2. Background Information

Due to the possibility of airliner highjacking and other concerns, certain items have been prohibited by airlines for decades. For instance, knife blades over four inches long, firearms, fireworks, and dangerous chemicals were all prohibited materials. After the terrorist attacks of Sep. 11, 2001, airlines and the Federal Aviation Administration (FAA) and the Department of Homeland Security (DHS) enacted new guidelines for airport and airplane security. These guidelines resulted in prohibiting the carrying on of all items that could be used as a weapon. Such confiscations included crochet needles, any pocketknives, razor blades, box cutters, nail clippers, etc. While the FAA/DHS has somewhat relaxed the rules, thereby allowing passengers to carry on, for example, cigar cutters, corkscrews, crochet needles, nail clippers, blunt tipped scissors, etc., items which are commonly carried by Americans on their persons are still prohibited.

Because of this, passengers, before they head to the airport for a flight, must remember to leave any such prohibited items behind. However, frequently an individual will forget to leave behind one of such prohibited items. For instance, an individual may have a valuable or keepsake item in the person's pocket/purse and not realize that it is a prohibited item or not realize that the item is still in his/her possession. At that point, the individual is faced with the prospect of either (1) returning to his/her car to place said item in their car (assuming that they drove their car to the airport), (2) placing their item in a storage locker (if available) at the airport, (3) giving their item to a friend that is not traveling with them (the person that drove them to the airport) for later retrieval, (4) mailing the item to himself or herself through the use of the post office facilities located at the airport, (5) placing the item in their baggage to be checked (presuming said baggage is still in their possession), or (6) throwing the item away. The amount of such confiscated materials that are thrown away or confiscated by the airport authorities by individuals who attempt to sneak them on anyway is extreme.

While passengers are prohibited from carrying on these prohibited items, typically, these items are deemed safe for transportation in checked baggage. For instance, a firearm cannot be carried onto a plane, but may be transported in the passenger's checked baggage.

What is needed is a method of allowing for a person to arrange for the carrying on board of the airplane of said valuable items in a secure manner with the other checked baggage. The present invention solves this need.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a system for providing for the transportation of a prohibited item owned by a passenger upon an airplane upon which said passenger is traveling. This system comprising a number of steps, these steps not necessarily in any particular order. A security bag for the secure transportation of said prohibited item is provided for the use of said passenger. This passenger able to place a prohibited item (such as a pocketknife) in said security bag. This security bag configured for sealing.

This security bag is coded with identification information identifying which passenger said prohibited item belongs to. The passenger being provided with notification of receipt of said security bag and deposit of said prohibited item therein. The security bag then subsequently being placed upon said vehicle, the same vehicle upon which said passenger is transported. Upon arrival at the passenger's destination, the security bag is retrieved from the vehicle. Upon confirming that the contents of the security bag belongs to the passenger through use of the identification information, the contents of the security bag and perhaps the security bag itself are returned to the passenger.

The purpose of the abstract of this disclosure is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein we have shown and described only the preferred embodiment of the invention, simply by way of illustration of the best mode contemplated by carrying out our invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a plan view of one embodiment of a security bag which could be utilized with the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a method of secure transportation of valuables upon an airplane. While the present invention discusses the transportation of valuables and prohibited items on an airplane, the disclosure of this invention is likewise adaptable and easily able to be used in other forms of transportation, including, but not limited to, ships, trains, automobiles, buses, etc.

In the preferred embodiment of the present invention, the present invention is a system for providing for the transportation of a “prohibited item” owned by a passenger upon an airplane upon which said passenger is traveling. A general discussion of one type of “prohibited item” can be found earlier in this disclosure.

In using the preferred embodiment of the present invention, the airport and/or airlines would provide for the use of a passenger(s), possibly for a nominal fee, security bags. These security bags for receiving therein prohibited items which the passenger is carrying on his/her person, which the person forgot to check into his/her checked baggage and/or leave at home. Most prohibited items can be transported upon an aircraft within the passenger's checked luggage, however, these same “prohibited items” cannot be transported onboard the aircraft upon an individual person or within an individual's carry-on luggage.

Thus, when a person standing in line at a security checkpoint realizes that he/she has a prohibited item on his/her person (for instance, a pocketknife), the passenger could place the prohibited item in one of the present invention's security bags.

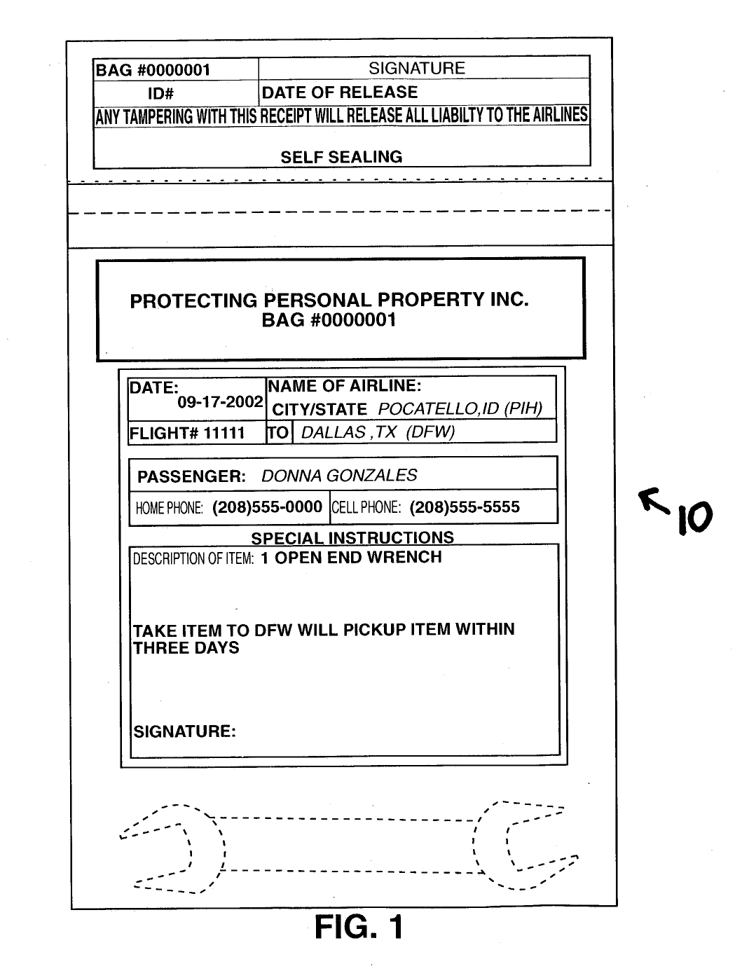

As shown in FIG. 1, the security bag 10 utilized with the present invention would be coded with identification identifying the contents of the security bag, the passenger to whom the contents belong to, as well as information regarding the travel itinerary of the passenger. The information regarding the travel itinerary is necessary in order for the airline to send the security bag containing the prohibited item on the passenger's flight as checked baggage so that the passenger's item will be awaiting him/her upon arrival at the destination airport.

It is envisioned that these bags will be tamper resistant and plastic so that they are inexpensive to manufacture. As such, it is envisioned that the bags would have a self-sealing feature allowing them to be sealed in a tamper resistant manner.

Upon placing the prohibited item within the security bag, the passenger and/or security professional at the airport would code the security bag with the appropriate information regarding the contents there enclosed. A receipt or other notification would be given to the passenger as proof of deposit of said prohibited item with the security professional. While this disclosure mentions a “security professional” obviously, such term is not intended to be exclusive in that the airport, DHS, airlines, etc. may designate whoever they choose to perform the task(s) described herein. The term “security professional” is intended to include any and all such individuals.

The security professional would then provide for the transfer of the security bag(s) in a timely manner to the passenger's awaiting aircraft. Upon arrival at the passenger's aircraft, the security bag would be preferably stowed with the rest of the passengers' luggage in the cargo compartment of the aircraft. At this point, such prohibited items are completely inaccessible to passengers upon the aircraft, and therefore pose no flight risk. In doing so, the airlines would follow standard procedures for handling baggage. It is preferred that security bags be grouped together, perhaps in their own container, for ease of handling.

Upon arrival at the airport to which the passenger is traveling, the airline and/or airport personnel would retrieve the security bag(s) from the cargo compartment of the aircraft and transport them to a location for distribution to passengers. For instance, the security bag could be sent to the airline's luggage office, whereby upon retrieving a passenger's usual luggage, the passenger could go to a separate office, present their ID as well as the coded information stub linking the passenger to the security bag, and receive their security bag with contents and/or just the contents of the security bag from the airport officials. Of course this being done in an unsecure portion of the airport before or beyond the security checkpoints.

Likewise, the security bags could be used for other purposes, including, but not limited to, the security bags being held at the departing airport until the passenger returns to pick it up, or the security bag being held at the departing airport until a third person, as noted by the passenger, arrives to retrieve the person items that the passenger left behind, etc.

This system comprising a number of steps, these steps not necessarily in a particular order. A security bag for the secure transportation of said prohibited item is provided for the use of said passenger. This passenger able to place a prohibited item (such as a pocketknife) in said security bag. This security bag configured for sealing.

This security bag coded with identification information identifying which passenger said prohibited item(s) belongs to. The passenger being provided with notification of receipt of said security bag and deposit of said prohibited item therein. The security bag then subsequently being placed upon said vehicle, the same vehicle upon which said passenger is transported. Upon arrival at the passenger's destination, the security bag is retrieved from the vehicle. Upon confirming that the contents of the security bag belongs to the passenger through use of the identification information, the contents of the security bag and perhaps the security bag itself are returned to the passenger.

Thus, in use, the present invention affords passengers four (4) alternative means to protect and retain prohibited items, while at the same time safeguarding other passengers. First, the passenger's property (“prohibited items”) can be transported to the passenger's final destination and released to the passenger upon arrival shortly thereafter. The present invention will be handled and transported in the same manner as check-in luggage. Second, the passenger's property could be kept and secured at the terminal of original departure for immediate pickup by the traveler upon his/her return. Third, the passenger's property could be kept at the original terminal and released to another person with the written permission of the passenger. Fourth, the passenger's property can be relinquished and the passenger can give the property to the authorities to dispose of properly.

The concept of the present invention is to prevent the loss of personal property due to the new prohibited items laws by the DHS and new screening of passengers at travel locations. The uniqueness of the present invention is that it provides the passenger with an additional means of protecting property against loss, theft, etc., and a way to travel with items that they wish to utilize at a later location.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A system for providing for the transportation of a prohibited item owned by a passenger upon the vehicle upon which said passenger is traveling, said system comprising the steps of:
providing a security bag for the secure transportation of said prohibited item;
placing said prohibited item in said security bag;
sealing said security bag;
coding said security bag with identification information identifying which passenger said prohibited item belongs to;
providing said passenger with notification of receipt of said security bag and deposit of said prohibited item therein;
securely placing said security bag upon said vehicle;
transporting said security bag with said passenger;
retrieving said security bag from said vehicle;
confirming said security bag belongs to said passenger through use of said identification information; and
returning said security bag to said passenger.

2. The system of claim 1, wherein said system is initiated adjacent an airport security checkpoint.

3. The system of claim 1, wherein said step of transporting said security bag with said passenger comprises said security bag being transported in a separate cargo compartment from a passenger compartment in which said passenger is transported.

4. The system of claim 1, wherein said security bag is comprised of plastic.

5. The system of claim 1, wherein the step of providing said passenger with notification of receipt of said security bag and deposit of said prohibited item therein comprises the utilization of a passenger receipt configured for detachment, said receipt bearing at least one identification marking associated with the particular security bag.

6. The system of claim 1, wherein the step of coding said security bag with identification information identifying which passenger said prohibited item belongs to comprises a worksheet permanently attached to said security bag, said worksheet configured for receipt of information regarding the passenger and said passenger's travel information.

7. A system for providing for the transportation of a prohibited item owned by a passenger upon an airplane upon which said passenger is traveling, said system comprising the steps of:
providing a security bag for the secure transportation of said prohibited item adjacent an airport security check-point;
placing said prohibited item in said security bag;
sealing said security bag;
coding said security bag with identification information identifying which passenger said prohibited item belongs to;
providing said passenger with notification of receipt of said security bag and deposit of said prohibited item therein;
securely placing said security bag upon said airplane in said cargo compartment;
transporting said security bag on the same airplane upon which said passenger is traveling;
retrieving said security bag from said cargo compartment;
confirming said security bag belongs to said passenger through use of said identification information; and
returning said security bag to said passenger beyond the arriving airport's security checkpoint.

8. The system of claim 7, wherein said security bag is comprised of plastic.

9. The system of claim 7, wherein the step of providing said passenger with notification of receipt of said security bag and deposit of said prohibited item therein comprises the utilization of a passenger receipt configured for detachment, said receipt bearing at least one identification marking associated with the particular security bag.

10. The system of claim 7, wherein the step of coding said security bag with identification information identifying which passenger said prohibited item belongs to comprises a worksheet permanently attached to said security bag, said worksheet configured for receipt of information regarding the passenger and said passenger's travel information.

11. A system for providing for the transportation of a prohibited item owned by a passenger upon an airplane upon which said passenger is traveling, said system comprising the steps of:
providing a security bag for the secure transportation of said prohibited item adjacent an airport security check-point;
placing said prohibited item in said security bag;
sealing said security bag;
coding said security bag with identification information identifying which passenger said prohibited item belongs to, said step further comprising a worksheet permanently attached to said security bag, said worksheet configured for receipt of information regarding the passenger and said passenger's travel information;
providing said passenger with notification of receipt of said security bag and deposit of said prohibited item therein, said step further comprising the utilization of a passenger receipt configured for detachment, said receipt bearing at least one identification marking associated with the particular security bag;
securely placing said security bag upon said airplane in said cargo compartment;
transporting said security bag on the same airplane upon which said passenger is traveling;
retrieving said security bag from said cargo compartment;
confirming said security bag belongs to said passenger through use of said identification information; and
returning said security bag to said passenger beyond the arriving airport's security checkpoint.

12. The system of claim 11, wherein said security bag is comprised of plastic.
